(19) United States
(12) Patent Application Publication
(10) Pub. No.: US 2005/0213751 A1
(43) Pub. Date: Sep. 29, 2005

(54) Methods and systems for generating transcodable encrypted content

(76) Inventors: John J. Apostolopoulos, Palo Alto, CA (US); Susie J. Wee, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/810,025

(22) Filed: Mar. 26, 2004

(51) Int. Cl. H04K 1/00; H04L 9/00

(52) U.S. Cl. 380/28

(57) ABSTRACT

Methods and systems for generating transcodable encrypted content that includes independently processable components are disclosed. In one embodiment, transcodable content is accessed that includes independently processable components to be encrypted. At least one of the independently processable components is encrypted to provide independently processable components which are independently decryptable. Moreover, the encrypting is performed using an encryption scheme that utilizes non-repeating identifiers that uniquely correspond to the independently processable components. The transcodable encrypted content is transcodable without requiring knowledge of the encryption scheme.

### TECHNICAL FIELD

Embodiments of the present invention relate to methods and systems for generating transcodable encrypted content.

### BACKGROUND ART

Effective data delivery systems should possess the capacity to deliver data streams to a multitude of diverse clients across heterogeneous networks that possess time-varying characteristics. The design of such data delivery systems present a variety of challenges for the designers of such systems. For instance, clients to which data is being delivered can possess various display, power, communication, and computational capabilities. In addition, communication links in the network over which data is being delivered can possess various maximum bandwidths, quality levels, and time-varying characteristics.

Providing effective security in order to protect content from eavesdroppers is another important consideration in the design of data delivery systems. Generally, to provide security, data is encrypted and transported in encrypted form. Encryption is the conversion of data into a form, called ciphertext that cannot be easily understood by unauthorized people. Encryption is important as a means of protecting content when any sensitive transaction is being carried out.

Intermediate nodes in the system may be used to perform stream adaptation, or transcoding, to scale data streams for different downstream client capabilities and network conditions. A transcoder takes a compressed, or encoded, data stream as an input, and then processes it to produce another encoded data stream as an output. Examples of transcoding operations include bit rate reduction, rate shaping, spatial downsampling, and frame rate reduction. Transcoding can improve system scalability and efficiency, for example, by adapting the spatial resolution of an image to a particular client's display capabilities or by dynamically adjusting the bit rate of a data stream to match a network channel's time-varying characteristics.

While network transcoding facilitates scalability in data delivery systems, it also presents a number of challenges. The process of transcoding can place a substantial computational load on transcoding nodes. While computationally efficient transcoding algorithms have been developed, they may not be well-suited for processing hundreds or thousands of streams at intermediate network nodes.

Furthermore, transcoding poses a threat to the security of the delivery system because conventional transcoding operations generally require that an encrypted stream be decrypted before transcoding. The transcoded result is re-encrypted but is decrypted at the next transcoder. Each transcoder thus presents a possible breach in the security of the system. This is not an acceptable situation when end-to-end security is required.

Compression, or encoding, techniques are used to reduce the redundant information in data, thereby facilitating the storage and distribution of the data by, in effect, reducing the quantity of data. The JPEG (Joint Photographic Experts Group) standard describes one popular, contemporary scheme for encoding image data. While JPEG is satisfactory in many respects, it has its limitations when it comes to current needs. A newer standard, the JPEG2000 standard, is being developed to meet those needs. In a similar manner, there have been a sequence of video compression standards including H.26112/3/4 and MPEG-1/2/4/21, speech and audio coding standards, as well as other standards for compression other types of media, e.g. graphics. As mentioned above, an important design goal for media compression standards and systems is the ability to adapt or transcode to different downstream network conditions and client capabilities.

Block cipher encryption schemes are encryption schemes that encrypt entire blocks of data at the same time. Some conventional block cipher encryption schemes apply a block cipher (such as Advanced Encryption Standard (AES) or Digital Encryption Standard (DES) or Triple DES (3DES)) in a chaining mode such as Cipher Block Chain (CBC) mode. However, block cipher encryption schemes such as this have a number of serious disadvantages related to their block-based granularity and overhead.

Schemes that apply block ciphers in a chaining mode require that an initialization vector be placed at the beginning of a block. This requirement leads to overhead that is related to the size of the block. In addition, applying block ciphers in a chaining mode requires that to recover a subset of the data bits in the block, the entire encrypted block must be retained and decrypted. The undesired data within the block corresponds to a form of padding which results in additional overhead. It should be appreciated that for blocks encrypted in this manner, transcoding of the encrypted content can only be performed at block boundaries (e.g., at content locations that lie at points found at integer multiples of the blocksize). This reliance on block boundaries results in undesirable overhead and limits transcoding flexibility. Moreover, the extraneous (unwanted) data can also complicate subsequent processing since any subsequent processing must identify the locations of the usable data and/or the locations of the extraneous data, thereby requiring additional book keeping, storage requirements, and careful indexing.

### DISCLOSURE OF THE INVENTION

Methods and systems for generating transcodable encrypted content that includes independently processable components are disclosed. In one embodiment, transcodable content is accessed that includes independently processable components to be encrypted. At least one of the independently processable components is encrypted to provide independently processable components which are independently decryptable. Moreover, the encrypting is performed using an encryption scheme that utilizes non-repeating identifiers that uniquely correspond to the independently processable components. The transcodable encrypted content is transcodable without requiring knowledge of the encryption scheme or encryption keys.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a system for generating and transcoding transcodable encrypted content according to one embodiment of the present invention.

FIG. 2 shows a transcodable encrypted content generator according to one embodiment of the present invention.

FIG. 3 shows an implementation of an encryptor according to one embodiment of the present invention.

FIG. 4 is a flowchart of the steps performed in a method for generating transcodable encrypted content according to one embodiment of the present invention.

FIG. 5 is a flowchart of the steps performed in a method for transcoding transcodable encrypted content according to one embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### OVERVIEW OF NOMENCLATURE AND TRANSCODABLE ENCRYPTED CONTENT GENERATING AND TRANSCODING INFRASTRUCTURE ACCORDING TO EMBODIMENTS OF THE PRESENT INVENTION

In the following discussion, embodiments of the present invention will be explicitly described in which transcodable content that includes independently processable components to be encrypted is accessed. It should be appreciated that at least one of the independently processable components can be encrypted to provide independently processable components which are independently decryptable. Moreover, the encrypting can be performed using an encryption scheme that utilizes non-repeating identifiers that uniquely correspond to the independently processable components. The transcodable encrypted content that is provided is transcodable without requiring knowledge of the encryption scheme.

For purposes of the following discussion the term “transcodable content” is intended to refer to content that is serviceable by a transcoder. Moreover, the term “transcodable encrypted content” is intended to refer to encrypted content that can be transcoded (e.g., serviced by a transcoder) without first being decrypted. In addition, the term “independently processable component” is intended to refer to independently identifiable content components that can be independently (e.g., separately) encrypted/decrypted, encoded/decoded and authenticated. Note that when a unit is independently decodable what is meant is that the meaning of its bits are understood and the unit is individually useful, however the unit alone may not be sufficient to recover the original media signal. For example, in MPEG with I, P, and B frames, each P or B frame is independently decodable, however additional coded frames (e.g. the prior I frame) is required to accurately reconstruct the video signal. By independently authenticatable, what is meant is that the independently processable component can have a message authentication code (MAC) (also referred to as an integrity check or cryptographic checksum) for verifying that the component has not changed. A change can be intentional, such as by a malicious attacker, or unintentional, such as by a channel error.

It should be appreciated that the terms “Secure Streaming” and “Secure Transcoding” are intended to refer to a content streaming/transcoding methodology that allows untrusted servers, transcoders and receivers to stream, transcode or adapt content for downstream network and client conditions, without knowing of what the content is comprised. As such, where “Secure Streaming” and “Secure Transcoding” is employed, a server, or mid-network node or proxy, does not require an encryption key to perform streaming or transcoding operations. In this manner, the content security can be maintained across a network infrastructure that includes untrusted components.

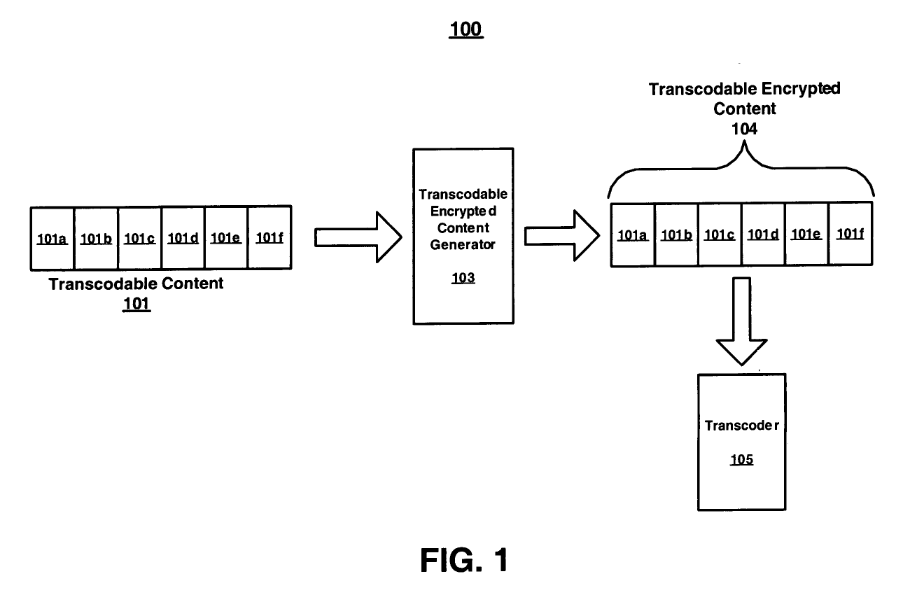

FIG. 1 shows components of an infrastructure 100 that accommodates the generation and transcoding of transcodable encrypted content 104 according to one embodiment of the present invention. In the embodiment of FIG. 1, transcodable content (e.g., 101) that includes independently processable components, typically shown as 101a-101f, is accessed and encrypted to generate transcodable encrypted content 104. The transcodable encrypted content 104 that is generated can then be accessed and transcoded by a transcoder (e.g., 105) for a desired purpose. According to exemplary embodiments, transcoder 105 can transcode (e.g., service) the transcodable encrypted content without requiring knowledge of the encryption scheme used to encrypt at least one independently processable component of the transcodable encrypted content accessed by transcoder 105.

Referring to FIG. 1, transcodable content 101 is supplied to the transcodable encrypted content generator 103. According to one embodiment, transcodable content 101 can include independently processable components typically shown as 101a-101f. According to one embodiment, transcodable content 101 can be encoded in a manner that facilitates transcoding such as by transcoder 105. According to one embodiment, transcodable content 101 can be transcoded by the selection and combining of a selected subset of the independently processable components (e.g., 101a-101f) that constitute transcodable content 101. According, to one embodiment, the resulting transcodable encrypted content is also transcodable.

Transcodable encrypted content generator 103 accesses transcodable content 101 and generates transcodable encrypted content 104. In the present embodiment, transcodable encrypted content generator 103 is configured to associate non-repeating identifiers that uniquely correspond to independently processable components (e.g., 101a-101f) with the independently processable components (e.g., 101a-101f) to which they correspond. The transcodable encrypted content 104 that is generated can be accessed by a transcoder (e.g., 105).

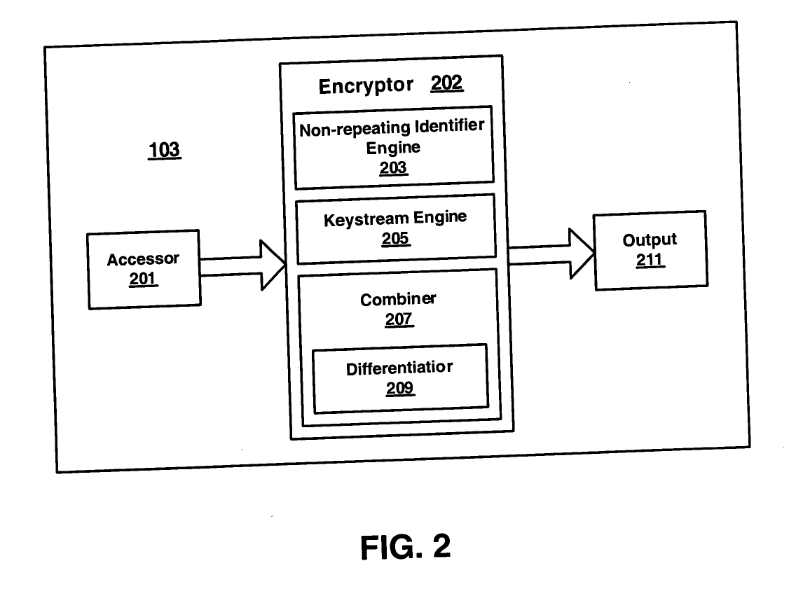

In the present embodiment, the transcodable encrypted content generator 103 can reside at either a server or a client, or be located remotely from either one. Moreover, the components that constitute the transcodable content generator 103 (see FIG. 2 discussion) can reside at the same location. Alternatively, one or more components of the transcodable content generator 103 can be distributed among separate locations in a network.

Transcoder 105 accesses transcodable encrypted content from transcodable encrypted content generator 103. Transcoder 105 can transcode (e.g., scale, perform a service upon) the transcodable encrypted content 104 for a particular purpose (e.g., such as to match downstream client capabilities, etc.). In the present embodiment, transcoder 105 can perform transcoding on transcodable encrypted content 104 without requiring knowledge of the encryption scheme used to encrypt at least one independently processable component (e.g., 101a-101f) that is supplied to it via the transcodable encrypted content 104 that it accesses.

Transcoder 105 can be used to perform stream adaptation, or transcoding, or to scale data streams for different downstream client capabilities and network conditions. Transcoder 105 takes a compressed, or encoded, data stream as an input, and then processes it to produce another encoded data stream as an output. Examples of transcoding operations include bit rate reduction, rate shaping, spatial downsampling, and frame rate reduction. Transcoding can improve system scalability and efficiency such as by adapting the spatial resolution of an image to a particular client's display capabilities or by dynamically adjusting the bit rate of a data stream to match a network channel's time-varying characteristics. Various other forms of adaptation can be used for different media types. For example, speech and audio signals can have their audio bandwidths, bit rates, or quality reduced. Audio signals can also have the number of channels adapted, e.g. multi-channel audio, or stereo, or single-channel (monophonic) audio. Images and video can have the color reproduction altered, e.g. from color to black-and white. Computer graphics (synthesized) media can have the quality of the synthesize adapted, e.g. the number of polygons or voxels can be reduced.

FIG. 2 shows a transcodable encrypted content generator 103 according to one embodiment of the present invention. Transcodable encrypted content generator 103 accesses transcodable content (e.g., 101 of FIG. 1) and generates transcodable encrypted content 104 from the transcodable content that it accesses. Transcodable encrypted content generator includes accessor 203, encryptor 202, and output 211. The encryptor includes non-repeating identifier engine 203, keystream engine 205, combiner 207 and differentiator 209.

Accessor 201 accesses transcodable content that includes independently processable components (e.g., 101a-101f in FIG. 1) from a source of transcodable content (e.g., server, storage etc.). The accessor 201 supplies the transcodable content that is accessed to encryptor 202. According to one embodiment, the independently processable components (e.g., 101a-101f of FIG. 1) that are accessed by accessor 201 are independently decodable and independently authenticatable.

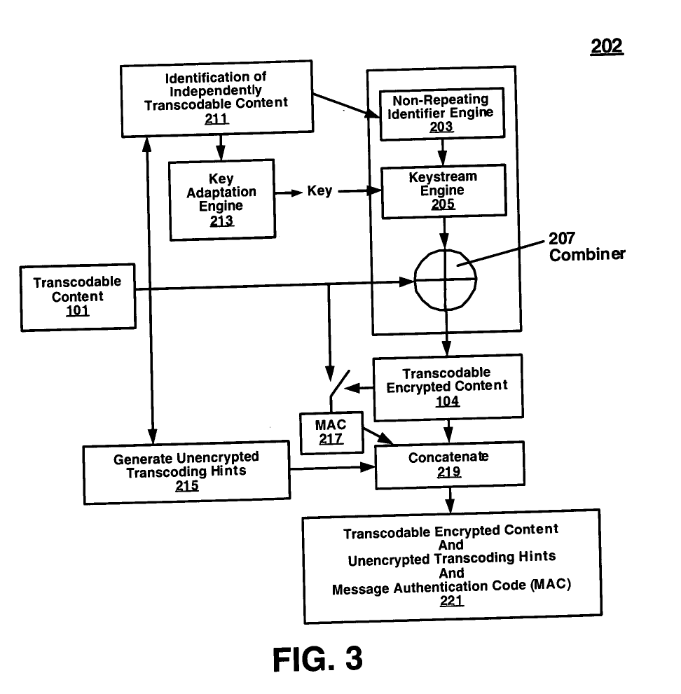

Encryptor 202 accesses transcodable content 101 supplied by accessor 201 and encrypts at least one of the independently processable components 101a-101f that constitute transcodable content 101. According to one embodiment, this manner of encryption provides transcodable encrypted content 104 that is comprised of independently processable components which are also independently decryptable. As mentioned above, encryptor 202 includes non-repeating identifier engine 203, keystream engine 205, combiner 207 and differentiator 209 (see descriptions of these components made with reference to FIG. 3 below).

In the present embodiment, encryptor 202 can comprise a block-stream cipher engine that applies block ciphers in stream cipher mode. In one embodiment, this manner of encryption is implemented by using counter (CTR) mode stream cipher encryption techniques. In alternate embodiments, other manners of applying block ciphers in stream cipher mode are employed, for example output feedback (OFB), as well as stream ciphers such as RC4, SEAL, WAKE. It should be appreciated that the independently processable components 101a-101f of the transcodable encrypted content 104 that is generated from stream cipher encryption can be independently decryptable and/or independently decodable and/or independently authenticatable.

It should also be appreciated that CTR mode stream encryption provides ciphertext that has the same length as the plaintext from which it is derived. Consequently, the overhead that can be incurred in adjusting plaintext to correspond to an integer number of block sizes is avoided (which is necessary when using some conventional approaches). Moreover, CTR mode stream encryption can involve bit or byte level encryptions and, as such, is not dependent on the cipher block size. Additionally, CTR mode encryption provides fine grain encryption such that fine grained identification and accessing of elicited portions of encrypted content tracts (e.g., such as a subset of a set of bit-sized portions of encrypted content) is facilitated (e.g., such as for transcoding the portions of encrypted content).

More specifically, applying block ciphers in stream cipher mode eliminates the requirement that extra (unwanted) data be retained as padding for the encrypted content, (e.g., which results in a reduction of overhead). Moreover, the fine grained approach alluded to above avoids the necessity of transcoding the encrypted content at block boundaries (e.g., at content locations that lie at points found at integer multiples of the blocksize). This is important from both efficiency (overhead) and reduced system complexity points of view. It should be appreciated that the elimination of this necessity provides transcoding flexibility. Additionally, the elimination of the requirement to retain extraneous data in the encrypted content (e.g., padding) simplifies subsequent processing since any subsequent processing does not include the necessity of identifying the location of the usable data or the location of the extraneous data.

Output 211 outputs transcodable encrypted content 104 that can be supplied to downstream sources (e.g., transcoder, client, etc.). According to one embodiment, the transcodable encrypted content 104 which is output by output 211 can be transcoded by downstream sources without requiring knowledge of the encryption scheme that is used by encryptor 202.

Each transcodable encrypted content may include some unencrypted information (e.g. an unencrypted header) that provides hints or explicit directions for performing the transcoding of the encrypted content. These hints may include the rate-distortion (R-D) consequences of keeping or discarding the encrypted content in question. They may also include information about the dependence of this encrypted content on other encrypted content. Alternative information may include the acquisition/capture or display/presentation timestamp, media type (video or speech), or scalability information (e.g. spatial resolution, frame rate, bandwidth, subband information, bit rate, quality layer, bit plane, color component, channel for audio (single, which stereo channels, specific channels in a multichannels audio program, etc)).

FIG. 3 shows an implementation of encryptor 202 according to one embodiment of the present invention. FIG. 3 shows components, that according to one embodiment, can be employed to implement the various functional blocks of encryptor 202.

Referring to FIG. 3, non-repeating identifier engine 203 produces non-repeating identifiers that uniquely correspond to the independently processable components 101a-101f that constitute the transcodable content. In the present embodiment, the non-repeating identifiers represent values that are used only once (nonces). According to one embodiment, non-repeating identifier engine 203 can be implemented using a counter. In alternate embodiments, the non-repeating identifier engine can be implemented using other suitable producers of nonces. In some embodiments, a psuedo-random number can be employed as an input to the non-repeating identifier engine (e.g., such as to provide an initial point of reference to the counter where a counter is employed).

According to one embodiment, inputs to the non-repeating identifier engine can also include but are not limited to nonces such as byte number in file, byte number in packet, media packet number in compressed file, bit number in file, sequence number of transport packet in stream and transport packet number in file (by transport packet we mean, e.g. Internet Protocol (IP) packet, or a Real-Time Protocol (RTP) packet on top of IP), etc. Most forms have media coding have unique identifies associated with each independently decodable portion of the coded media, e.g. pixel at location (x,y), frame N, audio frame from time T1 to time T2, JPEG-2000 packet (associated to {Tile T, Resolution R, Layer L, Precinct P, and Layer L}), MPEG-4 slice M for frame N, graphics object X. etc. These unique identifies associated with the coded media can be used as the unique identifiers. The unique identifiers, or nonces, facilitate a direct identification of elicited portions of encrypted content. It should be appreciated that in one embodiment, these values are provided to a decryption module to facilitate the decryption of the encrypted content. These unique identifies may be transmitted unencrypted with the encrypted content (e.g. as part of the unencrypted header that may be associated with each transcodable encrypted component), or they may be sent out of band, or they may be available at the receiver/consumer of the encrypted content. The consumer should be able to determine the mapping between the unique identifiers and the transmitted encrypted content.

Keystream engine 205 encrypts the non-repeating identifiers (e.g., such as generated by a counter) generated by non repeating identifier engine 203 to generate a keystream. According to one embodiment, the non-repeating identifiers are encrypted with an encryption key to generate a keystream. The keystream engine 205 supplies the keystream that is generated to a combiner 207 which logically combines the keystream with plaintext content (e.g., transcodable content) to produce ciphertext content.

Combiner 207 logically combines keystream and plaintext (e.g., transcodable content) inputs to produce a cipher text (e.g., transcodable encrypted content) output. Combiner 207 is coupled to keystream engine 205 and a source of plaintext (e.g., transcodable content) content (not shown) which respectively supply the keystream and the plaintext content (e.g., transcodable content 101) to combiner 207. It should be appreciated that the combiner 207 comprises a differentiator 209 that accesses differentiating metadata (e.g., NONCEs) that corresponds to the independently processable components 101a-101f and associates the differentiating metadata with the independently processable components 101a-101f. Note that there are numerous methods for taking a keystream and plaintext to produce ciphertext.

The keystream engine is given a key, and this key may be adapted by key adaptation engine 213. The adaptation may occur as a function of time, length of file or packet stream, media type, access control priviledge, or even for every independently processable component. The sequence of keys may be structured, in that they are related to one another in some manner (e.g. by application of a hash chain), or they may be unstructured or independent of each other. Also note that if encryption and authentication are both used, they may be used with different keys.

Each independently processable component is identified in 211, and this information is used to produce a unique, non-repeating identifier for that independently processable component. Furthermore, this information may be used to signal a key adaptation or directly effect the selection of the next key.

The transcodable content may be used to generate transcoding hints in 215, which are left unencrypted and are then concatenated in 219 with the transcodable encrypted content to produce output 221 which consists of transcodable encrypted content and associated unencrypted transcoding hints.

Furthermore, the transcoding hints may also be encrypted, however with a different encryption key (and potentially a different encryption algorithm, e.g. a public key algorithm) than that used for encrypting the content. In this case, transcoders which may be given access to transcode the encrypted content (once again without decrypting the content) can be given the key for decrypting the transcoding hints (but not the key for decrypting the content). This approach provides access control for transcoding the encrypted content as well as access control for decrypting and consuming the content, and makes these two forms of access control independent.

For authentication, a message authentication code (MAC) in 217 can be computed on either the encrypted trancodable content or the unencrypted transcodable content, and the MAC can also be concatenated in 219 to produce the output 221 which consists of transcodable encrypted content and associated unencrypted (or encrypted) transcoding hints and MAC. Note that a MAC is often referred to as an integrity check or a cryptographic checksum.

### Exemplary Operations in Accordance with Embodiments of the Present Invention

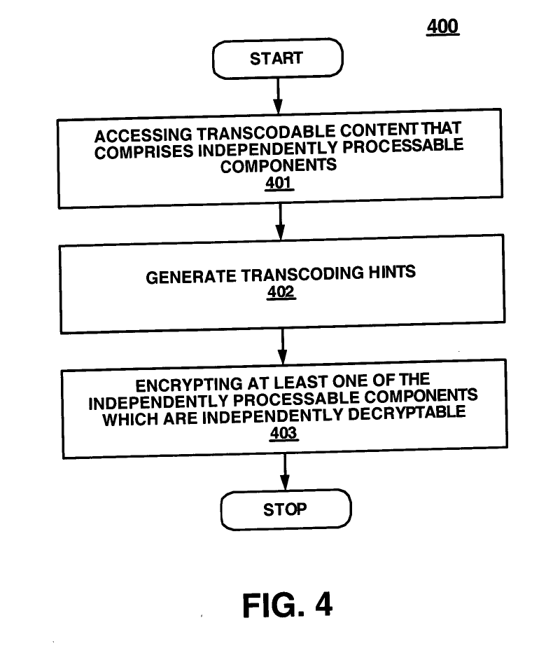

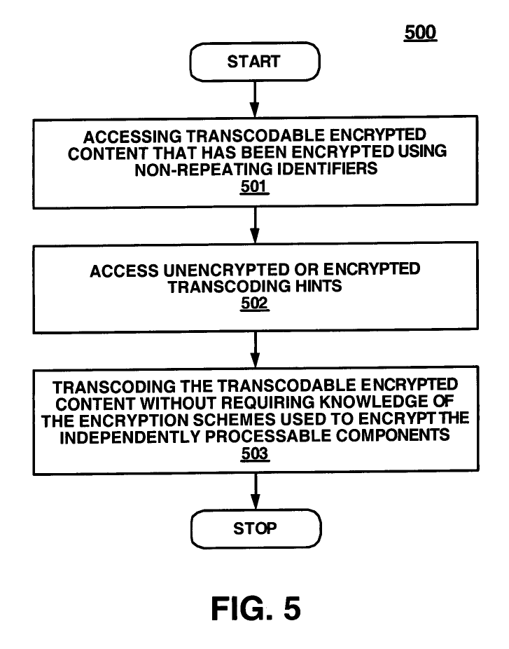

FIGS. 4 and 5 show flowcharts 400 and 500 of the steps performed in processes of the present invention which, in one embodiment, are carried out by processors and electrical components under the control of computer readable and computer executable instructions. The computer readable and computer executable instructions reside, for example, in data storage memory units. However, the computer readable and computer executable instructions can reside in other types of computer readable medium. Although specific steps are disclosed in the flowcharts, such steps are exemplary. That is, the present invention is well suited to performing various other steps or variations of the steps recited in the flowcharts. Within the present embodiment, it should be appreciated that the steps of the flowcharts may be performed by software, by hardware or by a combination of both.

FIG. 4 is a flowchart 400 of the steps performed in a method for generating transcodable encrypted content (e.g., 104 of FIG. 1) according to one embodiment of the present invention. According to exemplary embodiments, a transcodable encrypted content generator (e.g., 103 of FIG. 1) accesses transcodable content (e.g., 101 of FIG. 1) and generates transcodable encrypted content (e.g., 104 of FIG. 1) from the transcodable content (e.g., 101 of FIG. 1) that it accesses as is detailed in the exemplary steps described below.

At step 401, transcodable content (e.g., 101 of FIG. 1) that includes independently processable components is accessed. According to one embodiment, the transcodable content (e.g., 101 of FIG. 1) that is accessed is accessed by an accessor (e.g., 201 of FIG. 2). It should be appreciated that the accessor (e.g., 201 of FIG. 2) supplies the transcodable content (e.g., 101 of FIG. 1) that is accessed to an encryptor (e.g., 202 of FIG. 2). According to one embodiment, the independently processable components (e.g., 101a-101f of FIG. 1) are independently decryptable, independently decodable and independently authenticatable. At step 402, transcoding hints are generated.

At step 403, at least one of the independently processable components (e.g., 101a-101f of FIG. 1) that constitute the transcodable content (e.g., 101 of FIG. 1) is encrypted to provide transcodable encrypted content (e.g., 104 of FIG. 1) that has independently processable components (e.g., 101a-101f in FIG. 1) which are independently decryptable. The encryption is performed using an encryption scheme that utilizes non-repeating identifiers that uniquely correspond to the independently processable components (e.g., 101a-101f of FIG. 1). The transcodable encrypted content (e.g., 104 of FIG. 1) that is provided is transcodable without requiring knowledge of the encryption scheme that is used.

According to one embodiment, the non-repeating identifiers are generated by a non-repeating identifier engine (e.g., 203 of FIG. 2). In the present embodiment, the non-repeating identifiers constitute values that are used only once (nonces). According to one embodiment, the non-repeating identifier engine (e.g., 203 of FIG. 2) can be implemented using a counter. In alternate embodiments, the non-repeating identifier engine can be implemented using other suitable producers of nonces.

According to one embodiment, the non-repeating identifiers (e.g., such as generated by a counter) are encrypted using a keystream engine (e.g., 205 of FIG. 2) that generates an encrypted keystream. According to one embodiment, the non-repeating identifier values are nonces that may not repeat and which are encrypted with an encryption key to generate the keystream. The keystream engine (e.g. 205) supplies the keystream that is generated to a combiner 207.

According to one embodiment, at step 403, a combiner (e.g., 207 of FIG. 2) can be employed to logically combine keystream and plaintext (e.g., transcodable content) inputs to produce an encrypted cipher text output. In the FIG. 2 example, the combiner (e.g., 207 of FIG. 2) is coupled to a keystream engine (e.g., 205 of FIG. 2) and a source of plaintext (e.g., transcodable) content (not shown) which respectively supply keystream and plaintext (e.g., transcodable) content inputs to the combiner (e.g., 207 of FIG. 2). Moreover, according to one embodiment, the combiner can include a differentiator (e.g., 209 of FIG. 2) that can be employed to access differentiating metadata that corresponds to the independently processable components (e.g., 101a-101f of FIG. 1), and to associate the differentiating metadata with the independently processable components (e.g., 101a-101f of FIG. 1).

FIG. 5 is a flowchart of the steps performed in a method for transcoding transcodable encrypted content (e.g., 104 of FIG. 1) according to one embodiment of the present invention. According to exemplary embodiments, a transcoder (e.g., 103 of FIG. 1) accesses transcodable encrypted content (e.g., 101 of FIG. 1) and transcodes the transcodable encrypted content (e.g., 104 of FIG. 1) without requiring knowledge of the encryption scheme, keys, nounces, or other associated data used to encrypt at least one of its independently processable components (e.g., 101a-101f of FIG. 1).

At step 501, transcodable encrypted content (e.g., 104 of FIG. 1) that has been encrypted using non-repeating identifiers is accessed. The non-repeating identifiers uniquely correspond to independently processable components (e.g., 101a-101f of FIG. 1) (of which the transcodable content is constituted) such that the independently processable components (e.g., 101a-101f of FIG. 1) are independently decryptable. According to one embodiment, a transcoder (e.g., 105 of FIG. 1) accesses the transcodable encrypted content (e.g., 104 of FIG. 1) from a transcodable encrypted content generator (e.g., 103 of FIG. 1. In the present embodiment, the transcoder (e.g., 105 of FIG. 1) can perform transcoding on the transcodable encrypted content (e.g., 104 of FIG. 1) without requiring knowledge of the encryption scheme used to encrypt at least one of the independently processable components (e.g., 101a-101f of FIG. 1) of which the transcodable encrypted content (e.g., 104 of FIG. 1) is constituted (see step 503 below). At step 502, encrypted or unencrypted transcoding hints are accessed.

At step 503, the transcodable encrypted content (e.g., 104 of FIG. 1) is transcoded without requiring knowledge of the encryption scheme used to encrypt at least one of its independently processable components (e.g., 101a-101f of FIG. 1). It should be appreciated that embodiments of the present invention allow untrusted servers, transcoders and receivers to transcode or adapt content for downstream network and client conditions, without knowing what the content is. This mode of supplying content can be termed Secure Streaming and Secure Transcoding as the server does not require the encryption key to perform streaming or transcoding operations. In this manner, the security of the content is maintained.

The transcoding operation may be performed by using the unencrypted information which may be added to the transcodeable encrypted content (e.g. as an unencrypted header for each transcodeable encrypted content) to provide hints or explicitly direct the transcoding, as was discussed earlier in this application.

According to one embodiment, at step 503, such services as stream adaptation, or transcoding, or the scaling of data streams for different downstream client capabilities and network conditions can be securely performed. To perform such services, the transcoder (e.g., 105 of FIG. 1) takes a compressed, or encoded, data stream as an input, and then processes it to produce another encoded data stream as an output. Examples of transcoding operations include bit rate reduction, rate shaping, spatial downsampling, and frame rate reduction. Transcoding can improve system scalability and efficiency such as by adapting the spatial resolution of an image to a particular client's display capabilities or by dynamically adjusting the bit rate of a data stream to match a network channel's time-varying characteristics.

All the independently processable components may have the same encryption key, or each may have its own unique associated key. If multiple keys are used they can be related to one or more root keys via a mapping (e.g. key generation tool) such as a hash chain or tree. These conventional mapping tools enable the generation of multiple keys from one or more root keys. In addition, this mapping is one-way, in that each transition edge in the chain or tree can practically only be traveled in one direction. Hence, given the root key(s) all of the later keys can be generated. In addition, given a later key one can generate subsequent (even later) keys in the chain or tree. But given any key, it is not practically possible to generate earlier keys.

The use of multiple keys enables individualized access to different subsets of the encrypted content. For example, a user who has key A can decrypt and use all content encrypted with key A, while a user with key B can decrypt and use all content encrypted with key B. The use of multiple keys which are related via a mapping (e.g. hash chain or tree), enables individualized access to different subsets of the encrypted content, where the specific subset is determined by the mapping between keys and the associated content that is encrypted with those keys. For example, assume that there are five independently processable components, denoted {c0, c1, c2, c3, c4}, encrypted using the five different keys {k0, k1, k2, k3, k4}, respectively. Also assume that the five keys are related by a hash chain. That is, the root key k0 can be used to compute k1, which can be used to compute k2, which can be used to compute k3, which can be used to compute k4. Therefore, a user who is given key k0 can generate all of the other keys and decrypt all of the encrypted content. However, a user who is given key k2 can only generate keys k3 and k4, and therefore can only decrypt c2, c3, and c4.

In summary, embodiments of the present invention provide methods and systems for generating transcodable encrypted content that includes independently processable components. In one embodiment, transcodable content is accessed that includes independently processable components to be encrypted. At least one of the independently processable components is encrypted to provide independently processable components which are independently decryptable. Moreover, the encrypting is performed using an encryption scheme that utilizes non-repeating identifiers that uniquely correspond to the independently processable components. The transcodable encrypted content is transcodable without requiring knowledge of the encryption scheme, and the transcoded content preserves the properties of being independently decryptable, authenticatable, and decodable.

The foregoing descriptions of specific embodiments of the present invention have been presented for purposes of illustration and description. They are not intended to be exhaustive or to limit the invention to the precise forms disclosed, and it is evident many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method for generating transcodable encrypted content that comprises independently processable components, said method comprising:
accessing transcodable content that comprises independently processable components to be encrypted; and
encrypting at least one of said independently processable components to provide independently processable components which are independently decryptable, said encrypting performed using an encryption scheme that utilizes non-repeating identifiers that uniquely correspond to said independently processable components, wherein said transcodable encrypted content is transcodable without requiring knowledge of said encryption scheme.

2. The method as recited in claim 1 wherein said independently processable components comprise components that are independently decodable and independently authenticatable.

3. The method as recited in claim 1 wherein said encryption scheme comprises applying block ciphers in stream cipher mode.

4. The method as recited in claim 1 wherein said encryption scheme comprises counter (CTR) mode stream cipher encryption.

5. The method as recited in claim 1 wherein said encryption scheme comprises encrypting a counter to generate a keystream which is logically combined with plaintext to generate ciphertext.

6. The method as recited in claim 1 wherein said encryption scheme utilizes non-repeating identifiers which are non-repeating counter values.

7. The method as recited in claim 1 wherein said encryption scheme comprises performing several encryptions in parallel.

8. The method as recited in claim 1 wherein differentiating metadata that corresponds to said independently processable components is used as an input to said encryption.

9. The method as recited in claim 1 wherein said transcodable encrypted content has information associated with it to direct transcoding.

10. The method as recited in claim 1 said transcodable encrypted content comprises respective components that have respective encryption keys, wherein said respective encryption keys are related to a root encryption key.

11. The method as recited in claim 1 wherein said encryption scheme is selected from the group consisting of a block cipher used in output feedback (OFB) mode, RC4, SEAL, and WAKE.

12. A method for transcoding transcodable encrypted content that comprises independently processable components comprising:
accessing transcodable encrypted content that has been encrypted using non-repeating identifiers that uniquely correspond to said independently processable components such that said independently processable components are independently decryptable, and
transcoding said transcodable encrypted content without requiring knowledge of the encryption scheme used to encrypt said independently processable components.

13. The method as recited in claim 12 wherein said independently processable components comprise components that are independently decodable and independently authenticatable.

14. The method as recited in claim 12 wherein said encryption scheme comprises applying block ciphers in stream cipher mode.

15. The method as recited in claim 12 wherein said encryption scheme comprises counter (CTR) mode stream cipher encryption.

16. The method as recited in claim 12 wherein said encryption scheme comprises encrypting a counter to generate a keystream which is logically combined with plaintext to generate ciphertext.

17. The method as recited in claim 12 wherein said encryption scheme utilizes non-repeating identifiers which are non-repeating counter values.

18. The method as recited in claim 12 wherein said encryption scheme comprises performing several encryptions in parallel.

19. The method as recited in claim 12 wherein differentiating metadata that corresponds to said independently processable components is used as an input to said encryption.

20. The method as recited in claim 12 wherein said transcoding produces transcodable encrypted content that is smaller in size than the transcodable encrypted content that is accessed.

21. The method as recited in claim 12 wherein said transcodable encrypted content has information associated with it to direct transcoding.

22. The method as recited in claim 12 said transcodable encrypted content comprises respective components that have respective encryption keys, wherein said respective encryption keys are related to a root encryption key.

23. The method as recited in claim 12 wherein said encryption scheme is selected from the group consisting of a block cipher used in output feedback (OFB) mode, RC4, SEAL, and WAKE.

24. A transcodable encrypted content generator for generating transcodable encrypted content that comprises independently processable components, said transcodable encrypted content generator comprising:
an accessor for accessing transcodable encrypted content that comprises independently processable components to be encrypted; and
an encryptor coupled to said accessor for encrypting at least one of said independently processable components to provide independently processable components which are independently decryptable, said encryptor further comprising:
a non-repeating identifier engine that produces non-repeating identifiers that uniquely correspond to said independently processable components; and
an output coupled to said encryptor, said output outputting transcodable encrypted content which is transcodable without requiring knowledge of an encryption scheme used by said encryptor to encrypt said at least one of said independently processable components.

25. The transcodable encrypted content generator of claim 24 wherein said accessor is configured to access independently processable components that are independently decodable and independently authenticatable.

26. The transcodable encrypted content generator of claim 24 wherein said encryptor comprises:
a block-stream cipher engine that applies block ciphers in stream cipher mode.

27. The transcodable encrypted content generator of claim 24 wherein said encryptor comprises:
a counter (CTR) mode stream cipher encryptor.

28. The transcodable encrypted content generator of claim 24 wherein said encryptor further comprises:
a keystream engine which encrypts a counter to generate a keystream; and
a combiner coupled to said keystream engine, said combiner configured to logically combine said keystream with plaintext to generate ciphertext.

29. The transcodable encrypted content generator of claim 24 wherein said non-repeating identifier engine is configured to produce non-repeating identifiers which are non-repeating counter values.

30. The transcodable encrypted content generator of claim 24 wherein said encryptor is configured to perform several encryptions in parallel.

31. The transcodable encrypted content generator of claim 24 wherein said encryptor further comprises:
a differentiator which accesses differentiating metadata that corresponds to said independently processable components and associates the differentiating metadata with the independently processable components.

32. The transcodable encrypted content generator of claim 24 wherein said transcodable encrypted content has information associated with it to direct transcoding.

33. The transcodable encrypted content generator of claim 24 wherein said transcodable encrypted content comprises respective components that have respective encryption keys, wherein said respective encryption keys are related to a root encryption key.

34. The transcodable encrypted content generator of claim 24 wherein said encryption scheme is an encryption scheme selected from the group consisting of a block cipher used in output feedback (OFB) mode, RC4, SEAL, and WAKE.
